(19) United States
(12) Patent Application Publication
(10) Pub. No.: US 2015/0312174 A1
(43) Pub. Date: Oct. 29, 2015

(54) HYBRID DATA TRANSMISSION METHOD AND RELATED HYBRID SYSTEM

(71) Applicant: Wistron Corporation, New Taipei City (TW)

(72) Inventors: Chun-Yen Chang, New Taipei City (TW); Wei-Cherng Liao, New Taipei City (TW); Alexander I-Chi Lai, New Taipei City (TW)

(21) Appl. No.: 14/340,585

(22) Filed: Jul. 25, 2014

(30) Foreign Application Priority Data
Apr. 29, 2014 (TW) 103115380

(51) Int. Cl. H04L 12/931; G06F 13/40; H04L 12/721; G06F 13/42

(52) U.S. Cl. CPC H04L 49/604; G06F 13/4221; G06F 13/4022; H04L 45/66

(57) ABSTRACT

A hybrid data transmission method includes broadcasting a request via a first channel from a first host device, wherein the request comprises Internet protocol (IP) address information; replying to the request with a hardware address and a bus identity of a second host device via the first channel according to the IP address information when the second host device receives the request; transmitting the hardware address and the bus identity to a second interface controller when a first interface controller receives the hardware address and the bus identity; setting a second channel according to the hardware address and the bus identity when the second interface controller receives the hardware address and the bus identity; and transmitting a plurality of data packets between the first host device and the second host device via the second channel.

### BACKGROUND OF THE INVENTION

1. Field of the Invention

The present invention relates to a hybrid data transmission method and a related computer system, and more particularly, to a method of utilizing a peripheral component interconnect-express (PCI-E) interface for data transmission, and a related computer system.

2. Description of the Prior Art

With the rapid development in networking technology, the Internet has become a part of people's everyday lives. Ethernet is a networking technology for a local area network. Ethernet sends messages via multiple nodes on a radio system of the network, wherein each node has to obtain a cable or channel for transmitting messages. Each node has a globally unique 48-bit address, i.e. the MAC address of a network interface card, to ensure that all systems in the Ethernet can be distinguished from each other. In modern technologies, cross host communication utilizes the Ethernet for data transmission, while several super computers may adopt a specific high-speed bus interface standard, such as infini-band or proprietary, to carry out this data transmission.

In a computer system, the peripheral component interconnect-express (PCI-E) has the characteristics of maturity, high-speed and low-latency. In addition, the PCI-E interface mainly uses unicast for data transmission whereas Ethernet supports unicast and broadcast or multicast.

The present invention aims to integrate the PCI-E interface and the Ethernet for cross host communication.

### SUMMARY OF THE INVENTION

It is an objective of the present invention to provide a hybrid data transmission method, in order to realize cross host communication.

An embodiment of the invention discloses a hybrid data transmission method. The hybrid data transmission method comprises broadcasting a request via a first channel from a first host device, wherein the request comprises Internet protocol (IP) address information; replying to the request with a hardware address and a bus identity of a second host device via the first channel according to the IP address information when the second host device receives the request; transmitting the hardware address and the bus identity to a second interface controller when a first interface controller receives the hardware address and the bus identity; setting a second channel according to the hardware address and the bus identity when the second interface controller receives the hardware address and the bus identity; and transmitting a plurality of data packets between the first host device and the second host device via the second channel.

An embodiment of the invention further discloses a hybrid system. The hybrid system comprises a first host device, for broadcasting a request via a first channel, wherein the request comprises IP address information; a second host device, for replying to the request with a hardware address and a bus identity of the second host device via the first channel according to the IP address information when receiving the request; and a control unit. The control unit comprises a first interface controller, for transmitting the hardware address and the bus identity when receiving the hardware address and the bus identity; and a second interface controller, for setting a second channel according to the hardware address and the bus identity when receiving the hardware address and the bus identity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams of a hybrid system according to an embodiment of the invention.

FIG. 3 is a schematic diagram of a hybrid data transmission process according to an embodiment of the invention.

### DETAILED DESCRIPTION

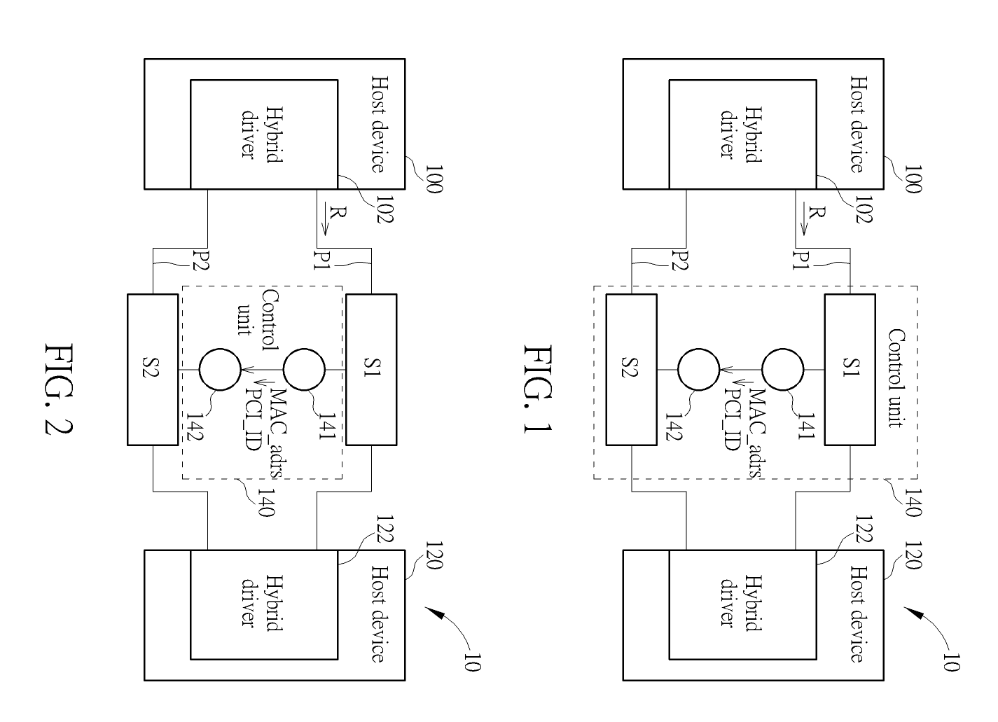

Please refer to FIG. 1, which is a schematic diagram of a hybrid system 10 according to an embodiment of the invention. The hybrid system 10 includes a host device 100, a host device 120 and a control unit 140. The host device 100 may be a computer system, such as a personal computer (PC), a laptop or a server. The host device 100 includes a hybrid driver 102. The basic structure of the host device 120 is the same as the host device 100, except that the host device 120 also includes a hybrid driver 122. The hybrid driver 102 and the hybrid driver 122 include driver programs for at least two types of interfaces. The host device 100 is utilized for broadcasting a request R via a channel P1, wherein the request R includes Internet protocol (IP) address information. The host device 120 may reply to the request with a hardware address MAC_adrs and a bus identity PCI_ID of the host device 120 via the channel P1 according to the IP address information. Preferably, the hardware address MAC_adrs may be a media access control (MAC) address. The bus identity PCI_ID may be a peripheral component interconnect-express (PCI-E) identity. The control unit 140 includes a first interface switch S1, a second interface switch S2, a first interface controller 141 and a second interface controller 142. The first interface controller 141 transmits the hardware address MAC_adrs and the bus identity PCI_ID to the second interface controller 142 when receiving the hardware address MAC_adrs and the bus identity PCI_ID. The second interface controller 142 sets a channel P2 between the hybrid driver 102 and the hybrid driver 122 according to the hardware address MAC_adrs and the bus identity PCI_ID when receiving the hardware address MAC_adrs and the bus identity PCI_ID. The first interface switch S1 is utilized for controlling the channel P1 to be turned on or off, and the second interface switch S2 is utilized for controlling the channel P2 to be turned on or off. As a result, the host device 100 and the host device 120 may transmit a plurality of data packets via the channel P2.

Please note that, in other embodiments of the present invention, the first interface controller 141, the second interface controller 142, the first interface switch S1 and the second interface switch S2 may not be integrated into the control unit 140; instead, they may be realized separately, as shown in FIG. 2.

When the first interface controller 141 receives the hardware address MAC_adrs and the bus identity PCI_ID of the host device 120, the first interface controller 141 transmits the hardware address MAC_adrs and the bus identity PCI_ID to the second interface controller 142 in order to set the channel P2. After the channel P2 is set up, the host device 100 and the host device 120 may transmit a plurality of data packets via the channel P2.

In an embodiment of the present invention, the channel P1 may be an Ethernet channel, and the channel P2 may be a PCI-E channel. In this case, the channel P1 uses broadcast or multicast for data transmission, and the channel P2 uses unicast for data transmission. The first interface controller 141 may be an Ethernet controller, and the second interface controller 142 may be a PCI-E controller.

The host device 100 may broadcast a request (i.e. the request R) including IP address information via an Ethernet channel (i.e. the channel P1). When receiving the request including the IP address information, the host device 120 confirms that the IP address information meets the IP address of the host device 120, and replies to the request with a MAC address (i.e. the hardware address MAC_adrs) and a PCI-E identity (i.e. the bus identity PCI_ID) of the host device 120 via the Ethernet channel. When an Ethernet controller (i.e. the first interface controller 141) receives the MAC address and the PCI-E identity of the host device 120, the Ethernet controller transmits the MAC address and the PCI-E identity of the host device 120 to a PCI-E controller (i.e. the second interface controller 142). When the PCI-E controller receives the MAC address and the PCI-E identity of the host device 120, the PCI-E controller sets a PCI-E channel (i.e. the channel P2) between the hybrid driver 102 and the hybrid driver 122. After the PCI-E channel is set up, the host device 100 and the host device 120 may transmit data packets using unicast via the PCI-E interface. When broadcast or multicast is utilized for data transmission, the first interface switch S1 may control the Ethernet channel to be turned on, and the host device 100 and the host device 120 may transmit data packets via the Ethernet channel. When unicast is utilized for data transmission, the second interface switch S2 may control the PCI-E channel to be turned on, and the host device 100 and the host device 120 may transmit data packets via the PCI-E channel.

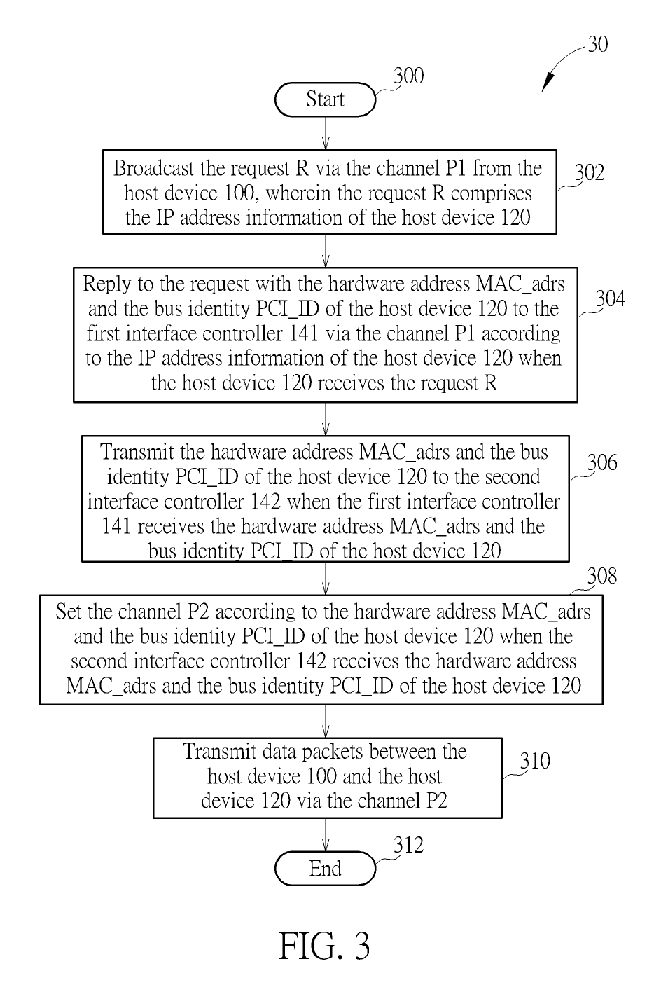

The operations related to the hybrid system 10 can be summarized into a hybrid data transmission process 30. Please refer to FIG. 3, which is a schematic diagram of a hybrid data transmission process 30, which includes the following steps:

Step 300: Start.

Step 302: Broadcast the request R via the channel P1 from the host device 100, wherein the request R comprises the IP address information of the host device 120.

Step 304: Reply to the request with the hardware address MAC_adrs and the bus identity PCI_ID of the host device 120 to the first interface controller 141 via the channel P1 according to the IP address information of the host device 120 when the host device 120 receives the request R.

Step 306: Transmit the hardware address MAC_adrs and the bus identity PCI_ID of the host device 120 to the second interface controller 142 when the first interface controller 141 receives the hardware address MAC_adrs and the bus identity PCI_ID of the host device 120.

Step 308: Set the channel P2 according to the hardware address MAC_adrs and the bus identity PCI_ID of the host device 120 when the second interface controller 142 receives the hardware address MAC_adrs and the bus identity PCI_ID of the host device 120.

Step 310: Transmit data packets between the host device 100 and the host device 120 via the channel P2.

Step 312: End.

Detailed implementations of the hybrid data transmission process 30 are illustrated above and will not be repeated herein.

To sum up, after the second host device receives the request broadcast by the first host device via the Ethernet channel, the second host device replies to the request with the hardware address and the bus identity of the second host device. When the Ethernet controller receives the hardware address and the bus identity of the second host device, the Ethernet controller transmits the hardware address and the bus identity of the second host device to the PCI-E controller, in order to set the PCI-E channel. After the PCI-E channel is set up, the first host device and the second host device may transmit data packets using unicast via the PCI-E channel. As a result, the embodiments of the present invention can integrate the Ethernet and the PCI-E interface, which achieves hybrid transmission mechanism to realize cross host communication.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A hybrid data transmission method, comprising:
broadcasting a request via a first channel from a first host device, wherein the request comprises Internet protocol (IP) address information;
replying to the request with a hardware address and a bus identity of a second host device via the first channel according to the IP address information when the second host device receives the request;
transmitting the hardware address and the bus identity to a second interface controller when a first interface controller receives the hardware address and the bus identity;
setting a second channel according to the hardware address and the bus identity when the second interface controller receives the hardware address and the bus identity; and
transmitting a plurality of data packets between the first host device and the second host device via the second channel.

2. The hybrid data transmission method of claim 1, wherein the first channel uses broadcast or multicast for data transmission and the second channel uses unicast for data transmission.

3. The hybrid data transmission method of claim 1, wherein the first channel is an Ethernet channel and the second channel is a peripheral component interconnect-express (PCI-E) channel.

4. The hybrid data transmission method of claim 1, wherein the hardware address is a media access control (MAC) address and the bus identity is a PCI-E identity.

5. The hybrid data transmission method of claim 1, wherein the first interface controller is an Ethernet controller and the second controller is a PCI-E controller.

6. A hybrid system, comprising:
a first host device, for broadcasting a request via a first channel, wherein the request comprises Internet protocol (IP) address information;
a second host device, for replying to the request with a hardware address and a bus identity of the second host device via the first channel according to the IP address information when receiving the request; and
a control unit, comprising:
a first interface controller, for transmitting the hardware address and the bus identity when receiving the hardware address and the bus identity; and
a second interface controller, for setting a second channel according to the hardware address and the bus identity when receiving the hardware address and the bus identity.

7. The hybrid system of claim 6, wherein the first host device and the second host device further transmit a plurality of data packets via the second channel.

8. The hybrid system of claim 6, wherein the first channel uses broadcast or multicast for data transmission and the second channel uses unicast for data transmission.

9. The hybrid system of claim 6, wherein the first channel is an Ethernet channel and the second channel is a peripheral component interconnect-express (PCI-E) channel.

10. The hybrid system of claim 6, wherein the hardware address is a media access control (MAC) address and the bus identity is a PCI-E identity.

11. The hybrid system of claim 6, wherein the first interface controller is an Ethernet controller and the second controller is a PCI-E controller.

12. The hybrid system of claim 6, further comprising:
a first interface switch, for controlling the first channel to be turned on or off; and
a second interface switch, for controlling the second channel to be turned on or off.
